(19) United States
(12) Patent Application Publication
(10) Pub. No.: US 2014/0025582 A1
(43) Pub. Date: Jan. 23, 2014

(54) Digital Token Generator, Server For Recording Digital Tokens and Method For Issuing Digital Token

(71) Applicant: egoNexus Limited, Hong Kong (CN)

(72) Inventor: Dmitry MAEVSKY, Kanagawa (JP)

(73) Assignee: egoNexus Limited, Hong Kong (CN)

(21) Appl. No.: 14/036,355

(22) Filed: Sep. 25, 2013

Related U.S. Application Data
(63) Continuation of application No. PCT/CN2011/072922, filed on Apr. 18, 2011.

(51) Int. Cl. G06Q 30/02

(52) U.S. Cl. CPC G06Q 30/0225; G06Q 30/0226
USPC 705/65

(57) ABSTRACT

A disconnected digital token generator is provided. which is capable of generating and displaying or delivering a digital token for a customer. The customer can take a picture of the digital token using a smart phone and then communicate with a server through a hyperlink represented by the picture using the smart phone. The disconnected digital token generator thus can be used for issuing a digital token without requiring any networks or logical connections.

### CROSS REFERENCE TO RELATED APPLICATIONS

This application is a continuation of PCT International patent application no. PCT/CN2011/072922, having an international filing date of 18 Apr. 2011, the contents of which are hereby incorporated by reference.

### FIELD OF INVENTION

The present invention relates to the field of devices and systems which issue digital tokens to recipients, the digital tokens representing redeemable points, cash rewards and so on, such as those in a loyalty reward programme.

### BACKGROUND OF THE INVENTION

One of the ways a retail business attracts customers is by rewarding customers with more goods or services through loyalty reward programmes. Typically, such loyalty reward programmes provide rewards in the form of loyalty points or redeemable points, given in an amount proportional to the value of a customer's purchase; the more the customer buys, the more points he or she is rewarded with. The redeemable points are subsequently useable in exchange of goods, services or cash from the same merchant the customer made a purchase from, or from another merchant participating in the same loyalty reward programme.

Setting up a loyalty reward programme can be quite difficult for some merchants. Other than having to design how to award redeemable points, merchants have to set up electronic systems to support the design. Typically, this means setting up client-devices at the merchants' locations or points of purchase, all connected to a server over a wide area network or the Internet. These client-devices send digital information to the server on purchases made by each customer, so that the server is able to monitor the amount of redeemable points earned and used by each customer, or the amount expired. To ensure that the loyalty reward programme is confidential and secured, a card with a magnetic strip or micro-chip uniquely identifying a customer is issued to the customer. A card reader in each client-device at the merchants' premises is required to read the card.

Any merchant may have his or her own tailored loyalty reward programme. As a result, it is not uncommon to find that a customer has to carry a dozen or more such cards of various merchants, which can be quite an annoyance. This limits the extent of attention that such loyalty reward programmes get from potential customers.

A common example of such a loyalty reward programme is the ‘Money Back’ programme in Hong Kong, where a certain amount of cash is given back to the customers in proportion to the amount spent. However, the merchants are required to implement an electronic card reader to read and credit the cash into the customer's cash card.

The trouble of implementation of such electronic card readers raises the entry barrier for merchants to participate in such loyalty reward programmes.

Given the technology, hardware, time and financial investment required to design, implement and maintain such electronic systems, there are merchants who resort to manual paper-based reward system, such as by issuing redemption coupons. However, this is not cumber-free, as the coupons must be designed, issued, redeemed and accounted manually, which is very labor intensive and prone to errors.

The high entry barrier for a merchant to participate in electronic loyalty reward programmes does not foster competitiveness in the market. Therefore, it is desirable to propose an apparatus and/or method which mitigate the difficulty for merchants to implement such loyalty reward programmes electronically.

### SUMMARY OF THE INVENTION

In a first aspect, the invention proposes a digital token generator, wherein the digital token generator is capable of generating a digital token, the digital token generator being further capable of providing the digital token to be copied by a customer, and the digital token generator is a disconnected digital token generator.

The invention provides the possibility that the customer receiving the digital token may use his or her own telecommunication network subscription or Internet connection to send the digital token safely to a server. The merchant is freed from having to subscribe to a communication network to send the information to a server himself or herself. The burden of subscribing to a communication network being so removed, this encourages the merchant to participate in loyalty programs using the disconnected digital token generator.

Preferably the digital token is a uniform resource locator (URL) by which the customer is able to communicate with a server using telecommunication means owned by the customer.

Optionally, the digital token is in the form of barcode. A barcode can be easily converted into text by image processing software. Thus, the barcode can be captured by an image capturing device, such as a smart phone camera.

The disconnected digital token generator is truly portable, as neither a physical nor logical connection to a computer or a network is required to generate the digital token, such that even a merchant who is selling his wares in a pushcart and having no network connection, including no telecommunication or no Internet, is able to use the digital token generator to issue digital tokens to his customers.

Optionally, the digital token may be ‘copied by the customer’ in the sense that the digital token is transmittable to a device of the customer by Near-Field Communication transmission.

Preferably, the digital token generator is a portable digital token generator. More preferably, the portable digital token generator is a pocket-size potable digital token generator. ‘Pocket-size’ means a size small enough to be carried in the pockets of general attires.

A digital token contains information relating to rewards or redeemable points which the merchant gives to the customers. Typically, the digital token includes the value of a purchase made by the customer from the merchant, a time-stamp and an identity of the digital token generator. Preferably, the digital token is cryptographically protected.

Advantageously, the time-stamp possibly ensures that every piece of information generated by the digital token generator is unique.

Optionally, the cryptographic protection is a digital signature which the server can authenticate. Optionally, the cryptographic protection is encryption which the server can decrypt.

In a second aspect, the invention proposes a server for recording digital tokens wherein, the server is capable of receiving a digital token generated by the digital token generator.

In a third aspect, the invention proposes a method of issuing a digital token comprising the steps of providing to a merchant a digital token generator capable of generating a digital token, the merchant generating a digital token and providing the digital token to a customer and, in order to claim a reward represented by the digital token, the customer electronically communicating the digital token to a server using a telecommunication device belonging to the customer.

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

### BRIEF DESCRIPTION OF THE DRAWINGS

FIG. 1 is an illustration of an embodiment of the invention;

FIG. 1a is an illustration of a website launched using the embodiment of FIG. 1;

FIG. 2 illustrates how the embodiment illustrated in FIG. 1 is used with an image capturing device;

FIG. 2a is an exemplary flowchart of the steps of using the embodiment of FIG. 1;

FIG. 3 is another exemplary flowchart of the steps of using the embodiment of FIG. 1;

FIG. 4 illustrates how the embodiment illustrated in FIG. 1 is used in a system implementing a customer loyalty reward programme; and

FIG. 4a illustrates a webpage which is launched using the embodiment of FIG. 1.

### DETAILED DESCRIPTION OF THE INVENTION

The present embodiment relates to a digital token generator which is useable to generate a digital token to be awarded to customers in a loyalty reward programme.

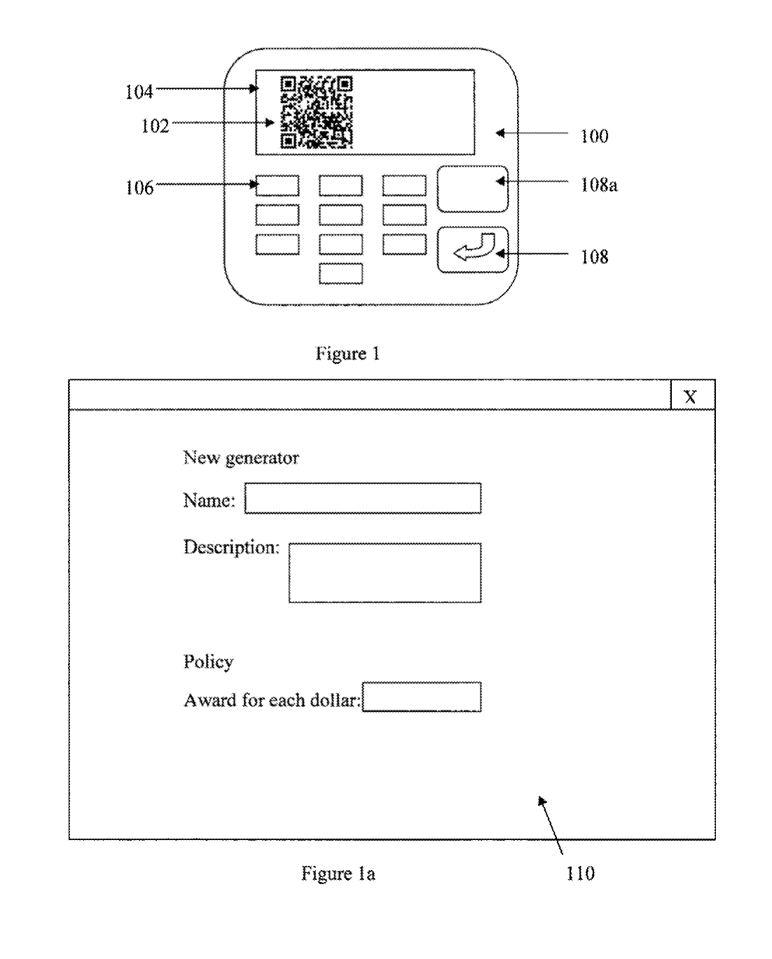

FIG. 1 is a schematic illustration of the digital token generator 100, showing that the digital token generator 100 comprises, among other necessary parts, a screen 104 for display, an input unit such as a keypad 106 of ten buttons for numerical entry, and an ‘Enter’ button 108 to execute a program in the digital token generator 100.

The digital token generator 100 is a standalone device which requires neither physical nor logical connection to a computer or a network to perform its intended functions. Such a device is typically termed a ‘disconnected’ device, according to common jargon used in the relevant field of technology. In other words, the digital token generator 100 is a ‘Disconnected Digital Token Generator’ 100.

Within the digital token generator 100 is also a timer, a processor and memory. The memory contains a ‘private key’ and a ‘public key’ pair. The memory also contains a unique identifier (ID) for identifying the digital token generator 100.

A private key is a piece of data that is used to cryptographically produce a digital signature for the contents of a digital message. The private key comes as part of a unique pair of private and public keys. The ‘public key’ is a corresponding piece of data that can be used to verify the digital signature.

Generally, ‘digital signing’ is a mathematical cryptography method for authenticating a digital message. A valid digital signature gives a recipient of a digitally signed message confidence that the message was created by a known sender, and that the message was not altered in transit.

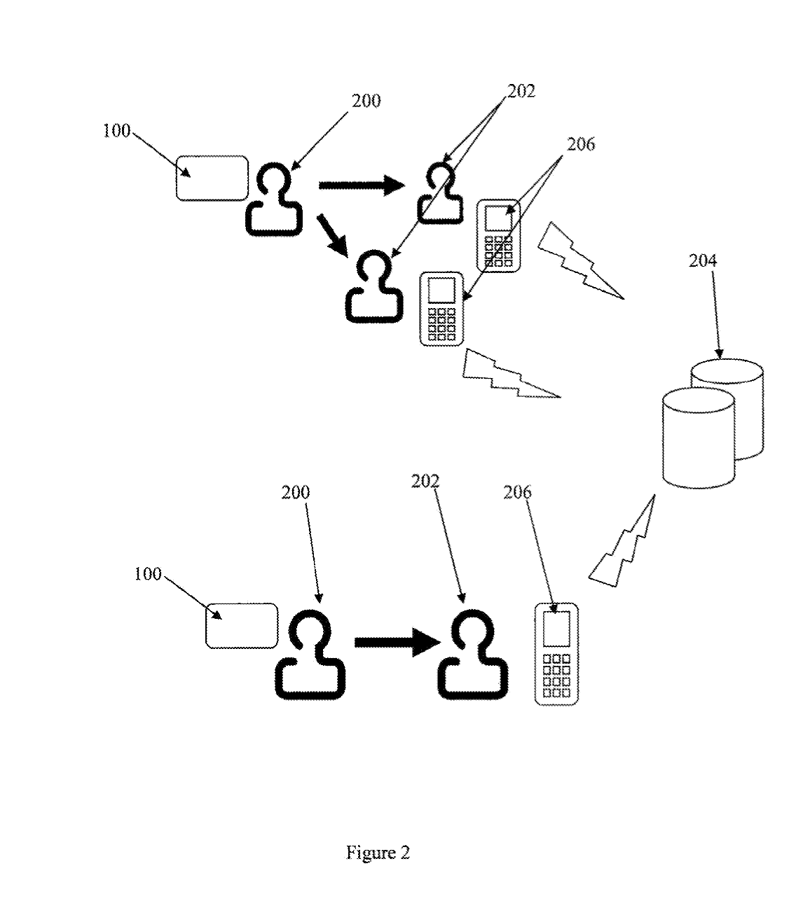

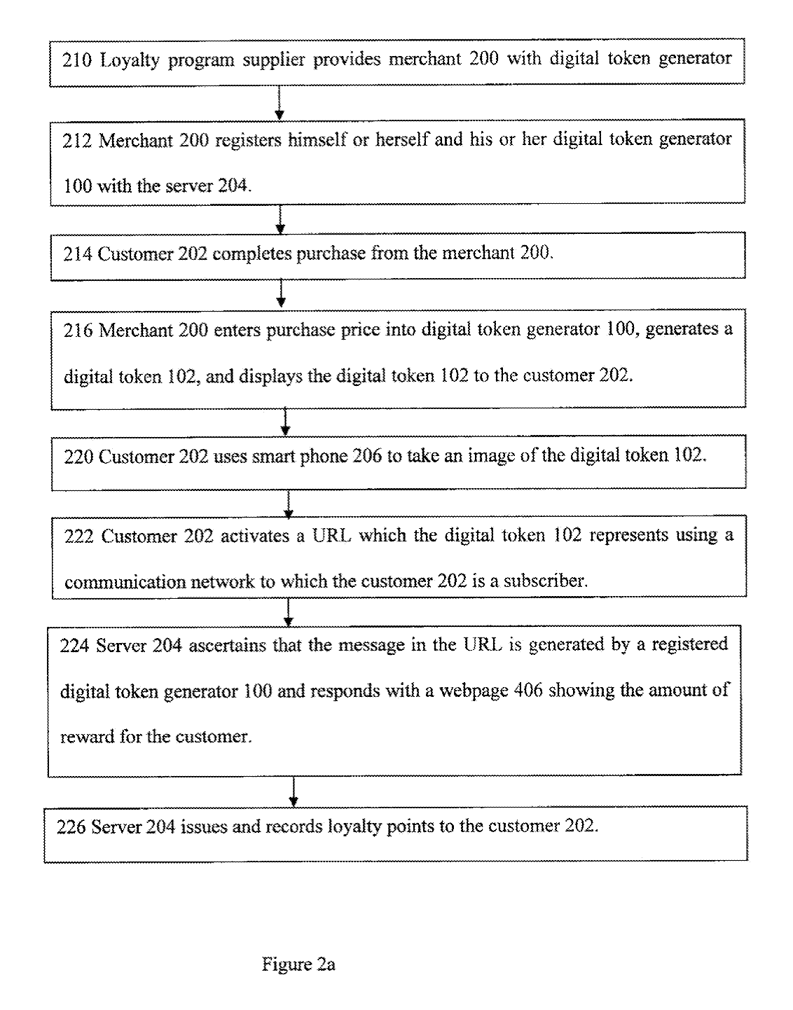

FIG. 2 schematically illustrates how the embodiment is used in a loyalty reward programme, involving a plurality of merchants 200 each owning a digital token generator 100 and a number of consumers 202 each owning a smart phone 206. A ‘smart phone’ 206 typically comprises a camera for image capturing, a digital image display and Internet browsing capabilities.

FIG. 2a is a flowchart showing exemplary basic steps in which the embodiment may be used. The digital token generators 100 are supplied by a loyalty reward programme supplier (programme supplier) to merchants 200 who wish to participate in the loyalty reward programme, at step 210.

After receiving a digital token generator 100, the merchant 200 registers himself or herself, and the digital token generator 100 into the loyalty reward programme by pressing an ‘initiation button’ 108a in the digital token generator 100, at step 212. The digital token generator 100 then displays a barcode 102 in the screen 104. The barcode 102 represents a URL (Uniform Resource Locator) which is a hyperlink to a server 204 of the loyalty reward programme. The unique identifier (ID) and the public key are included in the URL for registration. Typically, the server 204 is owned by the programme supplier.

The merchant 200 then takes a picture of the barcode 102 by his or her smart phone. The smart phone 206 has software for interpreting the barcode 102 to read the URL. Such software is known in the market and need not be elaborated on here. The merchant 200 then accesses the server 204 by activating the URL in the smart phone 206 and, in doing so, uploads the unique identifier (ID) and the public key into the server 204. The server 204 may now use the public key to authenticate any message signed with the private key of the digital token generator 100.

The server 204 has web server 204 capabilities and responds to the activation of the URL with a ‘policy’ webpage 110 where the merchant 200 may assign a ‘policy’ to the newly registered digital token generator 100 in the loyalty reward programme, such as specifying at the ‘policy’ webpage 110 the rewards he or she wishes to provide. FIG. 1a shows a simplified example of the ‘policy’ webpage 110. In practice, the registration and specification of the policy may be done by a sales agent of the programme supplier on behalf of the merchant 200.

After the merchant 200 has registered his or her digital token generator 100 into the loyalty reward programme, the merchant 200 may use the digital token generator 100 to reward the customers 202 immediately.

When a customer 202 has completed a purchase from the merchant 200, at step 214, the merchant 200 enters the purchase price into the digital token generator 100 using the numerical keypad 106, at step 216, and presses the ‘Enter’ key 108. The digital token generator 100 then generates a text string containing the purchase price, the unique identity of the digital token generator 100, a date-and-time stamp of the moment and then, using the private key, digitally signs the text string. The digitally signed text string is then included into a URL for contacting the server 204. The URL is presented as a barcode 102 in the screen 104 as illustrated in FIG. 1.

The barcode 102 in this embodiment is a digital token which is issued to customers so that customers may claim rewards using the digital token. The digital token generally comprises four basic components, namely, the purchase value, the unique identifier of the digital token generator 100, the timestamp and the digital signature.

The customer 202 then uses his or her smart phone 206 to take an image 404 of the barcode 102, at step 220. The smart phone 206 is able to read the URL represented by the barcode 102, using known barcode-reading software for smart phones. When the customer 202 activates the URL, the purchase price, the unique identity of the digital token generator 100, the date-and-time stamp and the digital signature are submitted to the server 204, at step 222.

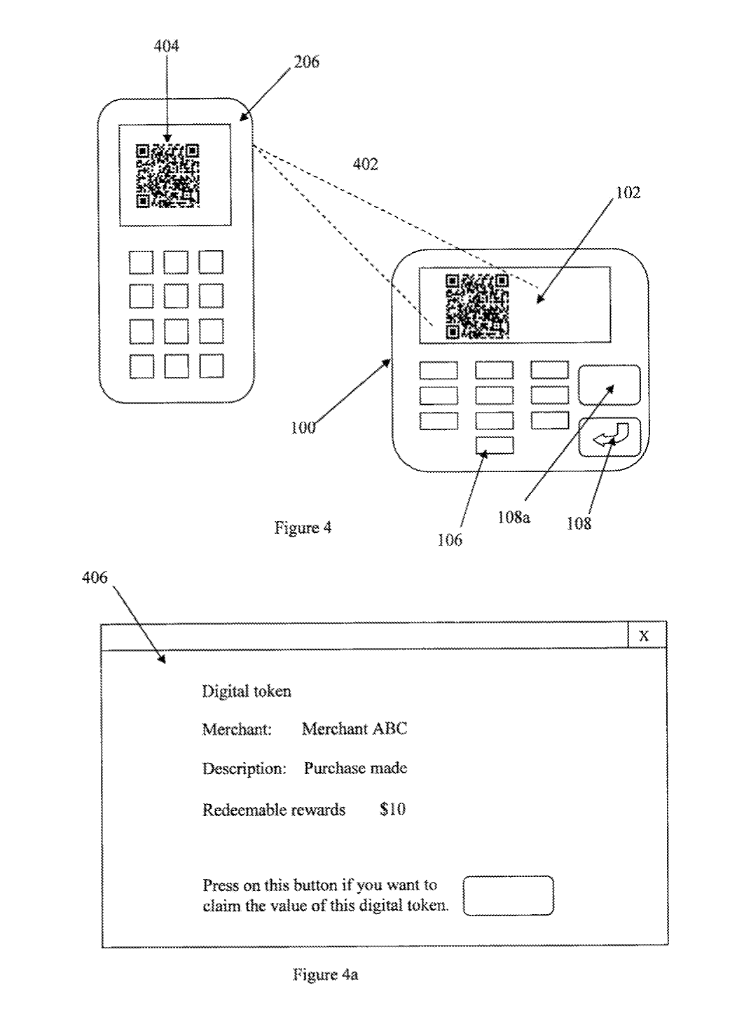

The server 204 then uses the unique identity of the digital token generator 100 to locate the registered public key in the server's database, and uses the public key to verify the digital signature, ascertaining that the message is generated by a digital token generator 100 belonging to the merchant 200 and that the message has not been modified in transit, at step 224. If the digital signature is not a recognized one, the access is ignored. If the signature is a recognized one, the server 204 responds with a webpage 406 such as that shown in FIG. 4a. The webpage 406 displays the amount of the customer's purchase and the reward which the customer 202 is able to receive for the purchase. The customer 202 may press on an OK button in the webpage 406 to accept the reward, at step 226.

In an optional policy of the loyalty reward programme known as the ‘Stamp Card Scheme’, rewards are issued in the form of ‘stamps’. A stamp is issued by the server 204 to the customer 202 when the customer 202 has accumulated a minimum value of purchases. Subsequently, when the customer 202 has accumulated a certain number of stamps, a cash reward is awarded and can be either used directly for online shopping or be transferred to the customer's bank, Paypal™ account or credit card account. If the customer 202 does not accumulate the number of stamps required to receive the cash reward within a specific period of time, the accumulated stamps will expire and be removed from the customer's account. Naturally, this scheme requires the customer 202 to sign up into the loyalty reward programme in order to register an account with the server 204 in advance.

In another optional policy, rewards are issued in the form of ‘redeemable points’ in an amount proportional to the value of purchase, which may be redeemed as cash after spending an equivalent amount at the same merchant for the second time. This reward scheme is known as the ‘Next Purchase Discount Scheme’.

In both described policies, the customer 202 does not need to contact the merchant 200 to receive rewards.

Optionally, historical records of the customer's purchases may affect the policies parameters, such as according ‘gold’ or platinum’ status to the customer 202 allowing for more generous rewards.

Furthermore, policies may be configurable by the merchant 200 to award varying amounts of redeemable points based on factors such as date and time of purchase, date and time of claim, and profile information of customer 202 such as demographic information.

The steps reiterate from step 214 in FIG. 2a for subsequent purchases made to the same merchant 200 by any customer 202.

In the preferred embodiment, the digital token generator 100 is a portable, pocket size device which bas an integrated battery designed to last for a long period of time. ‘Pocket size’ here means a size small enough to be carried in the trouser pockets of general attires or women's handbag and so on, about the size of mobile phones, as the skilled man would understand.

Any loyalty reward programme can be implemented quickly and easily using the digital token generator 100, as there is no need for installing magnetic card readers or client devices networked to a server 204. The digital token generator 100 does not need any peripheral devices, as the private key and the unique identity are contained within the digital token generator 100 and the keypad 106 is integral to the digital token generator 100. There is also no need for software installation in or modification to the digital token generator 100.

Communication of the digital token 102 to the server 204 leverages on existing telecommunication already subscribed and owned by the customers 202. Merchants 200 may therefore use the digital token generator 100 at any location without needing a digital network or the Internet. Even street vendors or pushcart vendors 200 are able to use the digital token generator 100 to issue rewards to customers 202 easily.

The embodiment is secured in several ways. The unique identity of each digital token generator 100 identifies the merchant 200 who owns the digital token generator 100. The digital signature ensures that no one is able to fake or modify a digital token 102. The date-and-time stamp ensures that each digital token 102 is unique.

Optionally, the programme supplier sets up a protection scheme in case the digital token generator 100 is stolen. For example, any token having the unique identity of a stolen digital token generator would be ignored.

In variations of the embodiment, the keypad 106, use of the barcode 102 and date-and-time stamp and so on, may each be selectively omitted.

It should be noted that each merchant 200 may register multiple digital token generators 100, each digital token generator 100 optionally having a unique pair of public and private keys for authentication of digital tokens or sharing the same pair of public and private keys with other digital token generators 100.

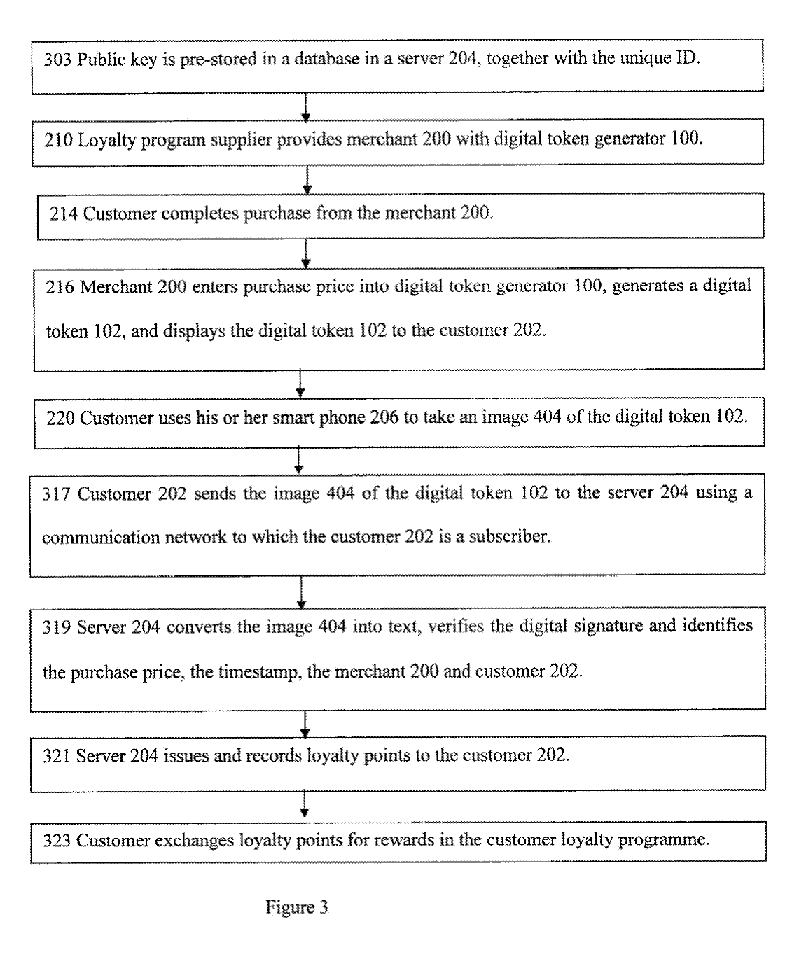

FIG. 3 illustrate a flowchart of a second way in which rewards may be given using the digital token generator 100. The steps which are similar to the flowchart of FIG. 2a, although not necessarily identical, are marked with the same reference numbers. In this embodiment, the public key and the unique identity of the digital token generator 100 is pre-stored in a database in a server 204, at step 303; unlike the earlier embodiment in FIG. 2a wherein the merchant 200 had to send the unique identity and public key to the server 204 to register the digital token generator 100. Thus, as soon as the digital token generator 100 is issued to the merchant 200, at step 210 the merchant 200 may use the digital token generator 100 to reward the customers 202 immediately.

After a customer 202 made a purchase, at step 214, the merchant 200 enters the purchase price into the digital token generator 100 using the numerical keypad 106, at step 216. The digital token generator 100 then generates a piece of text string containing the purchase price, the unique identity of the digital token generator 100 and also the date-and-time stamp of the moment. An example of the piece of text string is
“123.80*uni999*01Jan2011_{—}09:30:32”
   The part of the text string before the leftmost asterisk in the example is the financial value of the transaction, which may be in dollars or other currency unit. The part between the two asterisks is the unique identifier of the digital token generator 100 held by the present merchant 200. The part trailing the rightmost asterisk is a date-and-time stamp.

The digital token generator 100 then uses the private key to digitally sign the text string, and then converts the signed text string into a barcode 102. The barcode 102 is displayed on the screen 104, at step 216, as illustrated in FIG. 3. The customer 202 then uses the smart phone 206 to take an image 404 of the barcode 102, at step 202, and sends the barcode 102 to the server 204 by MMS (Multimedia Message Service) from his own smart phone, at step 317. Subsequently, the server 204 executes a program to convert the barcode 102 back into the text string, uses the public key to verify the digital signature and retrieves the purchase price, the unique digital token identity and the date-and-time stamp, at step 319.

The smart phone 206 number of the customer 202 is typically included in the MMS, which may be used by the server 204 to identify the customer 202. The server 204 then records the reward against the customer's smart phone 206 number 202, at step 321. The server 204 then awards ‘redeemable points’ to the customer 202, which the customer 202 may exchange for goods, services or cash, at step 323.

In this second embodiment, the customer's real identity and bank account need not be pre-registered in the server 204 before the customer 202 could enjoy the benefits of the loyalty reward programme, since the smart phone 206 number is globally unique (provided if the country and area codes are included). The customer 202 may be recognized and registered into the programme only when the customer 202 provides the smart phone 206 number to the programme supplier when collecting the redeemed goods or services. The programme supplier may cooperate with mobile phone 206 operators to authenticate the customer 202 by his or her mobile phone 206 number.

Similarly, the merchant 200 may register himself or herself into the programme after he or she has started using the digital token generator 100. As the digital token generator 100 is uniquely identifiable, and that digital signature prevents the record of the purchase amount paid by the customer 202 from being faked, the embodiment allows the merchant 200 to reward the customers 202 first and register later, which makes the embodiment very convenient.

In a variation of the second embodiment, the barcode 102 is converted back into the text string by a program in the smart phone 206, and not by a program stored in the server 204. An advantage of this is that the smart phone 206 can immediately alert the customer 202 if the image 404 of the barcode 102 is not readable.

In a third embodiment, the digital token generator 100 is used to issue electronic lottery tickets. The ‘lottery supplier’ has a role similar to the ‘programme supplier’ in the earlier embodiments. A lottery ticket vendor, having a role similar to that of the merchant 200 in the earlier embodiment, enters a customer's 202 pick of lottery numbers into the token generating device 100 and generates the barcode 102. The barcode 102 thus comprises the unique identity of the digital token generator 100, the picked lottery numbers and also a date-and-time stamp. If the customer 202 won the lottery, the customer 202 can simply identify himself or herself to the lottery supplier by his or her smart phone 206 number to collect the winnings. The winnings may be distributed by the server 204 or mobile operator who is able to authenticate the customer's identity by his or her mobile phone 206 number, on behalf of the lottery supplier.

Generally, the embodiments include a digital token generator 100, wherein the digital token generator 100 is capable of generating a digital token, the digital token generator 100 being further capable of providing the digital token to be copied by a customer 202, and the digital token generator 100 is a disconnected digital token generator 100.

Furthermore, the embodiments include a server 204 for recording digital tokens wherein, the server 204 is capable of receiving a digital token generated by the digital token generator 100.

Furthermore, the embodiments include a method of issuing a digital token comprising the steps of providing to a merchant 200 a digital token generator 100 capable of generating a digital token, the merchant 200 generating a digital token and providing the digital token to a customer 202, and, in order to claim a reward represented by the digital token, the customer 202 electronically communicating the digital token to a server 204 using a telecommunication device belonging to the customer 202.

While there has been described in the foregoing description preferred embodiments of the present invention. it will be understood by those skilled in the technology concerned that many variations or modifications in details of design, construction or operation may be made without departing from the scope of the present invention.

For example, although the word ‘customer’ is used in the description, the skilled man understands that the ‘customer’ may instead be a winner of a lucky draw, and so on.

Although the word ‘smart phone’ has been used in the description, the skilled man understands that ‘smart phone’ may be replaced by any device of the customer's which is able to send the digital token to the server, such as personal digital assistants (PDA), digital tablets and so on. In some instances, a desktop computer capable of accessing the Internet may be used to send the digital token to the server 204.

Other means of identifying the customer 202 than the smart phone 206 number may be used. such as the smart phone's SIM card number (subscriber identification module) or IMEI number (International Mobile Equipment Identity).

The digital token generator 100 may comprise a touch screen 104 instead of the keypad 106, or may be hooked up to a computer for data input using the computer's keyboard. Alternatively, neither keypad nor touch screen 104 is used but an accelerometer which triggers the generation of the digital token by sensing movements of the digital token generator 100.

Instead of being captured as a barcode 102 image, the digital token 102 may be transmitted by Near Field Telecommunication from the digital token generator 100 to the mobile device 206. This technology is commonly used in smart cards, where a value stored in the smart card is deducted when the smart card is tapped against the card reader. In this case, the smart phone 206 has Near Field Communication capabilities to receive the digital token from the digital token generator 100. Alternatively, any other electro-magnetic wave method may also be used to transfer the digital token from the digital token generator 100 to the mobile pone, such as WiFi, BlueTooth.

The token generating device 100 may be connected to a printer to print the barcode 102 on paper, the image of which may then be captured at the customer's leisure.

It is possible that the customer 202 may take a picture of the barcode 102 using a conventional camera, and then scan and send it by e-mail to the server 204, or using a dedicated digital camera, and then send it by e-mail to the server 204.

The digital token generator 100 may even be a smart phone 206 or any other programmable device equipped with software for producing the digital token.

Where it has been described that a digital signature is used, other cryptographic protection methods may be used instead, such as encryption of the information using the private key. In this case, the text string is encrypted using the private key, and is decrypt-able using the corresponding public key in the server 204. Digital signature allows a message to be read even if the message cannot be authenticated using the public key. Encryption, on the other hand, obfuscated the text which may be read only when decrypted using a suitable public key.

In a variation of the embodiments, the digital token generator 100 has the capability to generate the private and public keys when the initiation button is pressed; the private and public keys are not provided by the manufacturer and not pre stored in the digital token generator. Advantageously, the digital token generator 100 may be given by one merchant to another merchant, and the latter merchant is able to regenerate a new private and public key pair to use, for security purposes, as described in the embodiments.

In a variation of the embodiments, a hash function of the public key may be used as the unique identity of the digital token generator. Advantageously, only the public key needs to be transferred to the server, at step 212, without the unique identity of the digital token generator 100.

Optionally, the private and public keys are identical, known as a ‘symmetric’ key. Alternatively, the private and public keys are not identical, known as ‘asymmetric’ key pair.

1. A digital token generator, wherein:
the digital token generator is capable of generating a digital token;
the digital token generator being further capable of providing the digital token to be copied by a customer; and
the digital token generator is a disconnected digital token generator.

2. The digital token generator as claimed in claim 1, wherein:
the digital token includes a date-and-time stamp and an identity of the digital token generator; and
the digital token is cryptographically protected.

3. The digital token generator as claimed in claim 2, wherein:
the cryptographic protection is a digital signature.

4. The digital token generator as claimed in claim 2, wherein:
the cryptographic protection is encryption.

5. The digital token generator as claimed in claim 1, wherein:
the digital token is a uniform resource locator (URL) by which the customer is able to communicate with a server using telecommunication means owned by the customer.

6. The digital token generator as claimed in claim 1, wherein:
the digital token includes the value of a purchase.

7. The digital token generator as claimed in claim 1, wherein:
the digital token generator is a portable digital token generator.

8. The digital token generator as claimed in claim 7, wherein:
the portable digital token generator is a pocket-size portable digital token generator.

9. The digital token generator as claimed in claim 1, wherein:
the digital token is in the form of barcode.

10. The digital token generator as claimed in claim 1, wherein:
the digital token generator has Near Field Transmission capabilities to transmit the digital token to a device for receiving the digital token.

11. A server for recording digital tokens wherein:
the server is capable of receiving a digital token generated by the digital token generator as claimed in claim 1.

12. A method of issuing a digital token comprising the steps of:
providing a digital token generator operable by a merchant which is capable of generating a digital token,
the merchant generating a digital token and providing the digital token to a customer's telecommunication device; and,
the customer claiming a reward represented by the digital token by electronically communicating the digital token to a server using the telecommunication device.

13. The method of issuing a digital token as claimed in claim 12 wherein:
the generated digital token is an image, the customer's telecommunication device capturing the image of the digital token.

14. The method of issuing a digital token as claimed in claim 12 wherein:
the generated digital token is an image, the customer's telecommunication device having a camera for capturing the image of the digital token.

15. The method of issuing a digital token as claimed in claim 12 wherein:
the digital token is provided to the customer's telecommunication device using Near Field Communication to transmit the digital token from the digital token generator to the telecommunication device.

16. The method of issuing a digital token as claimed in claim 12, wherein:
the digital token includes a date-and-time stamp and an identity of the digital token generator; and
the digital token is cryptographically protected.

17. The method of issuing a digital token as claimed in claim 16 wherein:
the cryptographic protection is a digital signature; and further comprising:
the server authenticating the digital signature.

18. The method of issuing a digital token as claimed in claim 16 wherein:
the cryptographic protection is encryption; and further comprising:
the server decrypting the encryption.

19. The method of issuing a digital token as claimed in claim 16, wherein:
the digital token includes a value of a purchase.

20. The method of issuing a digital token as claimed in claim 12 wherein the digital token is a uniform resource locator (URL).

21. The method of issuing a digital token as claimed in claim 12 wherein the digital token is a barcode.

22. The method of issuing a digital token as claimed in claim 12 wherein:
the digital token generator is a disconnected digital token generator.
